(19) United States
(12) Patent Application Publication
(10) Pub. No.: US 2025/0217507 A1
(43) Pub. Date: Jul. 3, 2025

(54) INTERACTING WITH A SECURITY SYSTEM VIA A CHATBOT

(71) Applicant: HONEYWELL INTERNATIONAL INC., Charlotte, NC (US)

(72) Inventors: Deepika SANDEEP, Bangalore (IN); Banuprakash BALAKRISHNA, Udupi (IN); Siddhant Sharad GHUNGRUDKAR, Chandrapur (IN); Renil Austin MENDEZ, Trivandrum (IN); Nithin Yadalla RAMGOPAL, Bangalore (IN); Sreedhar Thirunellai RAMAN, Bangalore (IN)

(21) Appl. No.: 19/007,005

(22) Filed: Dec. 31, 2024

(30) Foreign Application Priority Data
Jan. 3, 2024 (IN) 202411000378
Apr. 30, 2024 (IN) 202411034280

(51) Int. Cl. G06F 21/62; G06F 21/31

(52) U.S. Cl. CPC G06F 21/6227; G06F 21/31

(57) ABSTRACT

A natural language query is received via a chatbot to monitor and/or control one or more security devices of the security system. The natural language query is processed to identify one or more descriptors of one or more security system devices that are a subject of the natural language query and to identify a desired result of the natural language query. One or more security system commands are assembled and submitted to the security system to identify one or more specific security system devices of the security system that correspond to the natural language query. One or more security system commands are assembled and submitted to each of the specific security system devices of the security system that are tailored to achieve the desired result. Confirmation from the security system is received.

### CROSS-REFERENCE TO RELATED APPLICATIONS

This application claims priority pursuant to 35 U.S.C. 119 (a) to Indian Application No. 202411000378, filed Jan. 3, 2024, and Indian Application No. 202411034280, filed Apr. 30, 2024, which applications are incorporated herein by reference in their entireties.

### TECHNICAL FIELD

The present disclosure relates generally to security systems, and more particularly to using a chatbot to interact with a security system.

### BACKGROUND

Security systems, particularly in large facilities, can be complex and include a large number of security components such as doors, cameras, sensors and other devices. Security system operators may be required to navigate through intricate menus and perform multiple steps on an operator console in order to execute commands to the security system and/or to assess the status of various security components. This can pose difficulties for inexperienced operators, and can consume considerable time even for experienced operators. What would be desirable are improved processes for a security system operator to issue commands to the security system, and receive feedback that the commands were successfully executed. What would be desirable is an intelligent chatbot that can assist security system operators to more efficiently interact with the security system, which may reduce the cognitive load on the security system operators and allow the security system operators to direct their attention on more important tasks.

### SUMMARY

The present disclosure relates generally to security systems, and more particularly to using a chatbot to interact with a security system. An example may be found in a method for interacting with a user via a chatbot to monitor and/or control one or more security devices of a security system of a facility. The illustrative method includes receiving a natural language query via the chatbot to monitor and/or control one or more security devices of the security system. The natural language query is processed to identify one or more descriptors of one or more security system devices that are a subject of the natural language query and to identify a desired result of the natural language query. This may be accomplished using a Large Language Model (LLM). The illustrative method further includes, based at least in part on the identified one more descriptors, assembling and submitting one or more security system commands to the security system to identify one or more specific security system devices of the security system that correspond to the natural language query. This may be accomplished using an Orchestration Engine, such as a LangChain Agent. The illustrative method further includes, based at least in part on the desired result, assembling and submitting one or more security system commands to each of the specific security system devices of the security system that are tailored to achieve the desired result, and in response, receiving a return message from the security system for each of the one or more security system commands submitted to each of the specific security system devices of the security system. This may also be accomplished using the Orchestration Engine, such as a Lang Chain Agent. The illustrative method includes, based at least in part on the one or more return messages from the security system, determining whether the desired result was achieved, and reporting via the chatbot whether the natural language query was carried out successfully, and if not, reporting one or more problems that were encountered. This may be accomplished, at least in part, using the Large Language Model (LLM).

Another example may be found in a system for monitoring and/or controlling a security system of a facility. The illustrative system includes a security system with a plurality of security system devices and a chatbot that is operatively coupled to the security system. The chatbot includes a chatbot user interface for receiving a natural language query from a user, a large language model interface for interfacing with a Large Language Model (LLM), and an orchestrator that is operatively coupled to the chatbot user interface, the large language model interface and the security system. The orchestrator is configured to provide the natural language query received via the chatbot user interface to the LLM via the large language model interface. The LLM is configured to identify and return one or more descriptors of one or more security system devices of the security system that are a subject of the natural language query and a desired result of the natural language query. The orchestrator is configured to assemble and submit one or more security system commands to the security system to identify one or more specific security system devices of the security system that correspond to the natural language query based at least in part on the identified one more descriptors. The orchestrator is configured to assemble and submit one or more security system commands to each of the specific security system devices of the security system that are tailored to achieve the desired result based at least in part on the desired result, and in response, receive a return message from the security system for each of the one or more security system commands submitted to each of the specific security system devices of the security system. The orchestrator and/or LLM is configured to determine whether the desired result was achieved based at least in part on the one or more return messages from the security system and to provide whether the natural language query was carried out successfully to the chatbot user interface.

Another example may be found in a method for interacting with a user via a chatbot to monitor and/or control one or more security devices of a security system of a facility. The illustrative method includes receiving a natural language query via the chatbot. Specific security devices of the security system that correspond to the natural language query are identified, which includes for example submitting one or more queries to the security system to identify one or more of the specific security devices that correspond to the natural language query. The natural language query is processed to identify a desired result to be achieved. The illustrative method includes determining and sending via the security system one or more security system commands to the specific security devices that are intended to achieve the desired result. The method includes determining whether the desired result was successfully achieved based on return messaged received from each of the specific security devices in response to each security system commands. Whether the natural language query was successfully achieved is reported via the chatbot.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system for monitoring and/or controlling a security system of a facility;

FIG. 2 is a schematic block diagram showing an illustrative architecture for the illustrative system of FIG. 1;

FIGS. 3A and 3B are flow diagrams that together show an illustrative method for interacting with a user via a chatbot;

FIG. 4 is a flow diagram showing an illustrative method for interacting with a user via a chatbot; and

FIG. 5 is a schematic illustration of using a chatbot to issue commands to a security system and receiving confirmation thereof.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

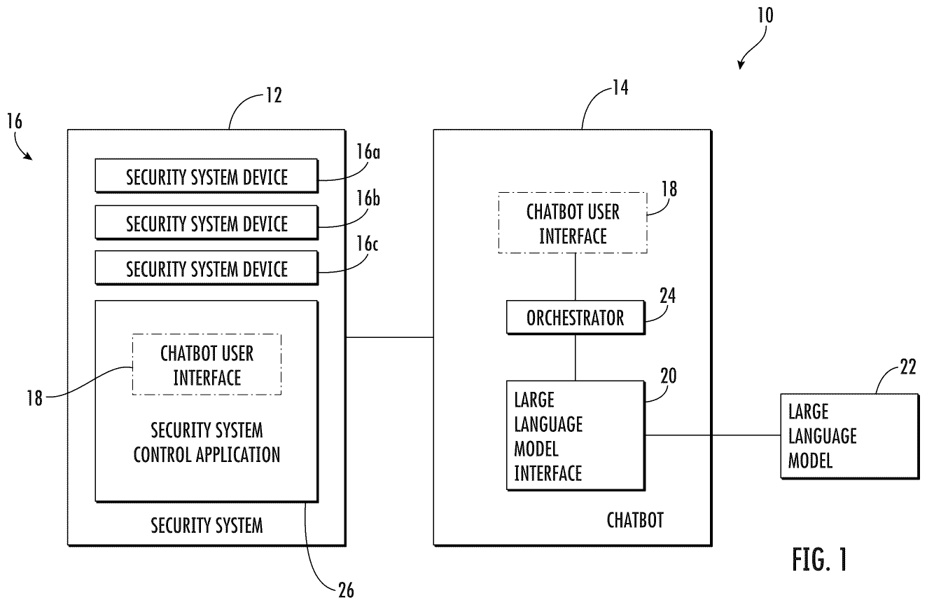

FIG. 1 is a schematic block diagram showing an illustrative system 10 for monitoring and/or controlling a security system of a facility. The illustrative system 10 includes a security system 12 and a chatbot 14 that is operatively coupled to the security system 12. The security system 12 includes a number of security system devices 16, individually labeled as 16a, 16b and 16c. While a total of three security system devices 16 are shown, this is merely illustrative, as the security system 12 may include any number of security system devices 16, and in some cases may include considerably more than three security system devices 16. The security system devices 16 may represent any of a number of different security system components, such as lockable doors, sensors, video cameras, and the like.

The chatbot 14 includes a chatbot user interface 18 that is configured to receive a natural language query from a user. The chatbot 14 includes a large language model interface 20 for interfacing with a Large Language Model (LLM) 22. The LLM 22 may be, for example GPT4, PaLM, Gemini, Grok, LLAMA, Claude, DBRX and/or any other suitable Large Language Model. An orchestrator 24 is operatively coupled to the chatbot user interface 18, the large language model interface 20 and the security system 12. The orchestrator 24 may include a LangChain agent. LangChain is a framework designed to simplify the creation of applications using large language models (LLMs). The orchestrator 24 is configured to provide the natural language query received via the chatbot user interface 18 to the LLM 22 via the large language model interface 20. The LLM 22 is configured to identify and return one or more descriptors of one or more security system devices of the security system that are a subject of the natural language query, and a desired result of the natural language query.

The orchestrator 24 is configured to assemble and submit one or more security system commands to the security system 12 to identify one or more specific security system devices 16 of the security system 12 that correspond to the natural language query based at least in part on the identified one more descriptors. The orchestrator 24 is configured to assemble and submit one or more security system commands to each of the specific security system devices 16 of the security system 12 that are tailored to achieve the desired result based at least in part on the desired result, and in response, receive a return message from the security system 12 for each of the one or more security system commands submitted to each of the specific security system devices 16 of the security system 12. In some cases, the orchestrator 24 may be configured to determine access rights of the user and to determine whether the user has access rights to each of the specific security system devices 16 of the security system 12, and if not, not submitting the one or more security system commands to the specific security system devices 16 of the security system 12 that the user lacks access rights. In some cases, the orchestrator 24 references a database that identifies each of the security system devices 16, the type and/or capabilities of each of the security system devices 16, the location of each of the security system devices 16 within the facility, the current state and/or status of each of the security system devices 16, the user rights associated with each of the security system devices 16, a historical log of activity associated with each of the security system devices 16, and/or any other suitable information and/or data.

The orchestrator 24 may be configured to determine whether the desired result was achieved based at least in part on the one or more return messages from the security system 12. The orchestrator 24 and/or the LLM 22 may report to the chatbot user interface 18 whether the natural language query was carried out successfully.

In some cases, the security system 12 may include a security system control application 26 running on an operator console that includes a plurality of menus that can be navigated to monitor and control each of the plurality of security devices 16 of the facility. In some cases, the chatbot user interface 18 may be integrated into the security system control application 26. In some cases, the security system control application 26 may include a floorplan that displays information for each of one or more of the plurality of security devices. The information displayed may include a location of the corresponding security device 16 on the floorplan. The information displayed may include an identifier of the corresponding security device 16. The information displayed may include a current status of the corresponding security device 16. As an example, the natural language query may include a reference to one or more of the security device identifiers displayed on the floorplan (e.g. lock the “west entrance door”), rather than the MAC address or other unique identifier of the security device.

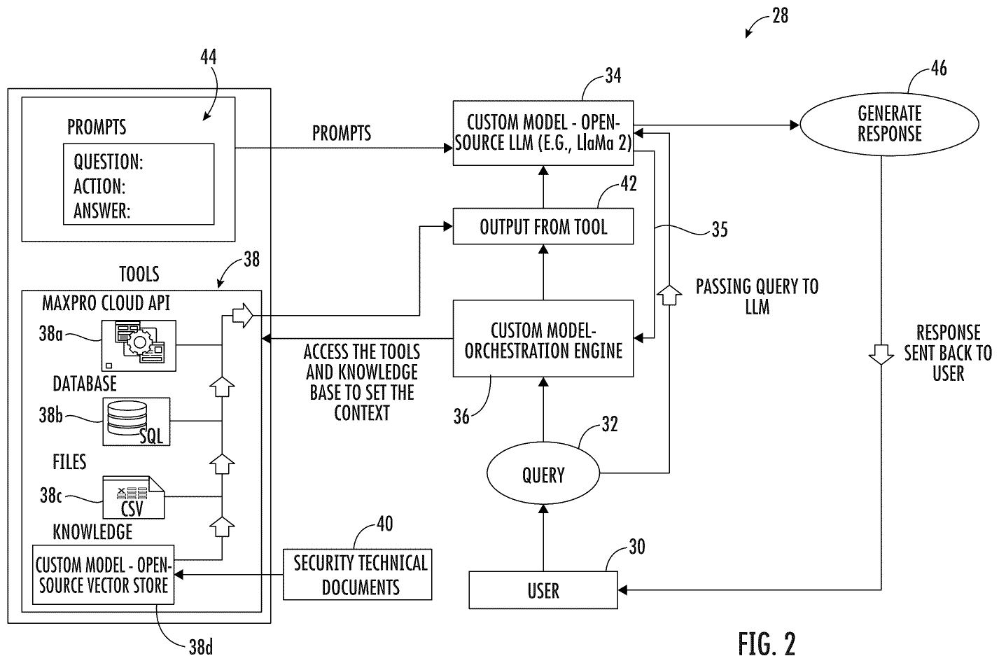

FIG. 2 is a schematic block diagram showing an illustrative architecture 28 for the chatbot 14. A user 30 provides a query 32. The query 32 may be a typed query such as a natural language text message. In some cases, the query 32 may be a verbal question that is captured and converted to text by a voice to text translator, for example. In some cases, the query 32 may be a question as to how to perform a particular step or process within a security system, for example. In some cases, the query 32 may not be a question, but instead may be a command for the security system to perform an act. The natural language query 32 may provide an elegant way for the user 30 to issue a command to the each of one or more security devices without having to go through a myriad of menus, pull-down boxes and the like in order to issue a command to each security device. Example natural language queries may include: “Are any of my devices offline showing an issue?”, “Pull up the video camera closest to the [Location XYZ] front door”, “Show me live video feeds from all cameras on the East entrance”, “List all the security incidents reported in the last 24 hours”, “Create a temporary access code for the maintenance team for today”, and “Provide a summary of security system health, highlighting any issues that require attention”. Additional example natural language queries include:

SOME EXAMPLES OF COMMANDS INCLUDE:

“what is status for door 2?”
“are there any issues with door 1?”
“list all doors which are online”
“list all offline doors”
“summarize my site info”
“give me the alarm status at my site”
“are there any active alarms at my site?”
“list all offline controllers”
“how many blocked doors at my site?”
“how many doors present at my site?”
“how many valid card holders are present?”
“are there any card holders with invalid cards?”
“get me contact details for all cardholders”
“get me user's access card details”
“block door 2”
“block door 2 if it is offline”
“block door 2 if it is online”
“check all doors if they are online and blocked, if yes unblock
them”
what is the status of door 1000?
how many total door are there?
get me a list of doors in blocked state
give me status of all doors
how many doors are open?
get me id of all doors
summarize my site information
what is the status of all doors?
give me status of door 6000 and unblock it
can u block all doors for me?
how many problematic doors are there? block them all
summarize all door information for me
give me a report of my alarms at my site
when was access card issued to User?

In the example shown, the query 32 passes to several elements within the chatbot 14. For example, the query 32 passes to an LLM 34 that may be considered an example of the LLM 34 shown in FIG. 1. The query 32 also passes to an orchestration engine 36 that may be considered as being an example of the orchestrator 24 shown in FIG. 1.

In response to receiving the query 32, the LLM 34 processes the natural language query 32 and identifies one or more descriptors of one or more security system devices that are a subject of the natural language query 32, and to identify a desired result of the natural language query 32. The LLM 34 may derive a context of the query 32 based on the query 32 itself and in some cases based on prior queries 32 of the user 30. The LLM 34 may report the one or more descriptors of one or more security system devices that are a subject of the natural language query 32 and the desired result of the natural language query 32 to the orchestration engine 36, as shown at 35. In some cases, the orchestration engine 36 itself may be equipped to processes the natural language query 32, identify one or more descriptors of one or more security system devices that are a subject of the natural language query 32, and identify a desired result of the natural language query 32, without invoking the LLM 34.

In the example shown, the orchestration engine 36 communicates with a number of tools 38, including but not limited to a cloud API (application programming interface) of the security system 38a, a database 38b, files 38c and an open source vector store 38d. The open source vector store 38d may vectorize knowledge extracted from security technical documents 40 for easy vector searching of that knowledge via a vector-based search engine. The security technical documents 40 may contain, among other things, local knowledge relevant to the particular security system (e.g. Maxpro Cloud Security system available from Honeywell International). The orchestration engine 36 identifies the most suitable tools 38 needed to collect relevant information from external systems to formulate a response to the query 32. For example, the orchestration engine 36 may make requests to the tools and knowledge base to obtain information and/or to control one or more security device in response to the natural language query 32, as indicated by the output from tool block 42. In the example shown, the LLM 34 receives the output from the tool block 42, along with the natural language query 32, and formulates a natural language response 46. The natural language response 46 may be a combination of the LLM's understanding, the data from external systems (e.g. data from block 42), and the initial query's context. The natural language response 46 may be provided back to the user 30 as shown. In some cases, this may result in the user 30 providing a subsequent query 32 in order to more closely find the information they are looking for, or to more precisely state a desired result they wish to achieve (e.g. lock all doors on the east and west entrances).

In some cases, the LLM 34 may receive in advance a number of prefix prompts 44 to help provide context to the LLM 34. For example, the prefix prompts 44 may include things such as:
You are a laconic assistant for a security system.
You reply with brief, to-the-point answers with no elaboration pertaining only to security systems.
For any query that does not relate to security systems respond with: “Apologies! I can only answer queries related to security systems”
The current date is (Current Date Here). Use this date when asked questions about relative dates like this year, last month, last 6 months and similar. When a question includes just a month with no year then assume the year is (current Year here).
Adhere to the following guidelines when responding to user queries:
   1) By default, if no specific date is mentioned in the query, the system will retrieve data from the past three months.
   2) If I am unable to determine the appropriate function or tool to use, I will respond by stating that I currently lack the capability to offer a solution to the question without asking the user for suggestions.
   3) As an AI language model, I can also provide information on hypothetical scenarios in addition to relying on historical data. My function is to offer insights and generate responses based on a mixture of both historical information and the context provided to me. Please feel free to ask any hypothetical questions or request information within a given scenario, and I'll do my best to assist you!
   4) Do not answer any kind of general knowledge questions.
   5) Remember Only use the functions you have been provided with.
   6) Previous_conversation_history:
      (History Here)
   Refer to the Previous_conversation_history to understand the ongoing context. Then, help me generate a response that takes that context into consideration. It's important that the response is coherent and informed by the prior discussion.
   As we continue our conversation, remember to look back at the previous discussion. This will help you maintain a consistent understanding of the topic and enable you to provide well-informed and contextually relevant answers.

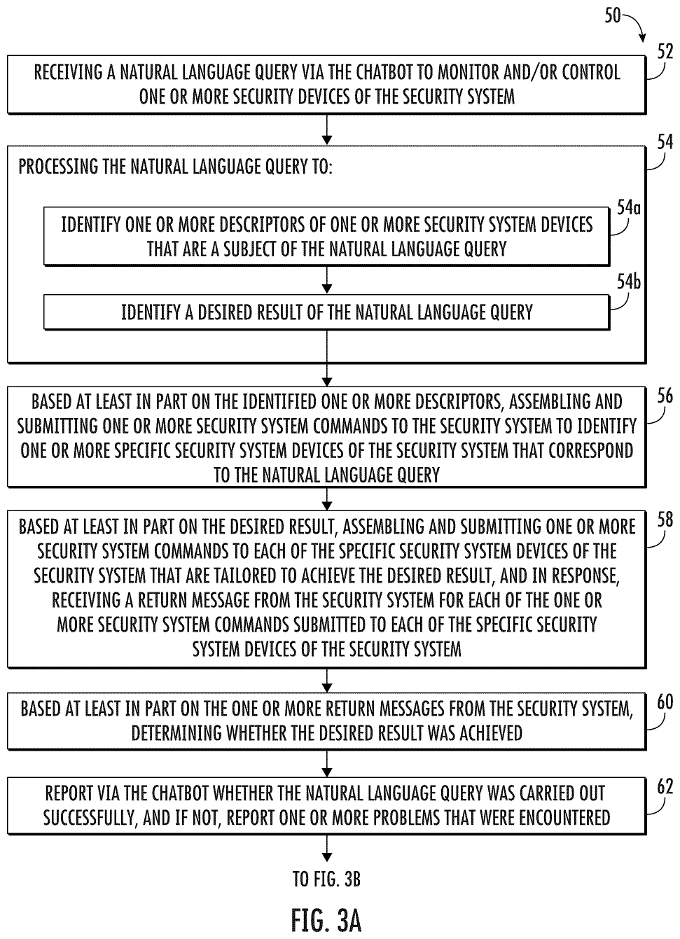

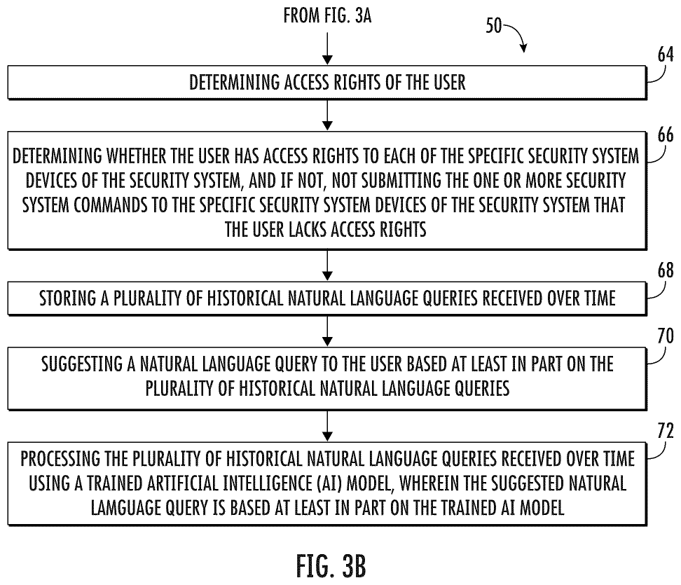

FIGS. 3A and 3B are flow diagrams that together show an illustrative method 50 for interacting with a user (such as the user 30) via a chatbot (such as the chatbot 14) to monitor and/or control one or more security devices (such as the security devices 16) of a security system (such as the security system 12) of a facility. The illustrative method 50 includes receiving a natural language query via the chatbot to monitor and/or control one or more security devices of the security system, as indicated at block 52. The natural language query is processed, as indicated at block 54. Processing the natural language query may include identifying one or more descriptors of one or more security system devices that are a subject of the natural language query, as indicated at block 54a. The one or more descriptors may identify one or more of a type of a security system device, a location of a security system device in the facility, a region of a security system device in the facility, and/or a current operational status of a security system device. Processing the natural language query may include identifying a desired result of the natural language query, as indicated at block 54b. Based at least in part on the identified one more descriptors, the method 50 may include assembling and submitting one or more security system commands to the security system to identify one or more specific security system devices of the security system that correspond to the natural language query, as indicated at block 56.

Based at least in part on the desired result, the method 50 may include assembling and submitting one or more security system commands to each of the specific security system devices of the security system. The security system commands may be tailored to achieve the desired result, and in response, receive a return message from the security system for each of the one or more security system commands, as indicated at block 58. The method 50 may include, based at least in part on the one or more return messages from the security system, determining whether the desired result was achieved, as indicated at block 60. In some cases, the method 50 may include reporting via the chatbot whether the natural language query was carried out successfully, and if not, report one or more problems that were encountered, as indicated at block 62.

In some cases, the natural language query may be processed by a Large Language Model (LLM) (such as the LLM 22) that identifies the one or more descriptors of one or more security system devices that are the subject of the natural language query and identify the desired result of the natural language query. An orchestrator (such as the orchestrator 24) may assemble and submit the one or more security system commands to the security system to identify the one or more specific security system devices of the security system that correspond to the natural language query. The orchestrator may assemble and submit the one or more security system commands to each of the specific security system devices of the security system, and may receive the return message from the security system for each of the one or more security system commands submitted to each of the specific security system devices of the security system. In some cases, the orchestrator may determine whether the desired result was achieved. An LLM, operatively coupled to the orchestrator, may report via the chatbot whether the natural language query was carried out successfully, and if not, may report one or more problems that were encountered.

In some cases, and continuing on FIG. 3B, the method 50 may further include determining access rights of the user, as indicated at block 64. The method 50 may further include determining whether the user has access rights to each of the specific security system devices of the security system, and if not, not submitting the one or more security system commands to the specific security system devices of the security system that the user lacks access rights, as indicated at block 66.

In some cases, the method 50 may include storing a plurality of historical natural language queries received over time, as indicated at block 68, and/or suggesting a natural language query to the user based at least in part on the plurality of historical natural language queries, as indicated at block 70. In some cases, the method 50 may include processing the plurality of historical natural language queries received over time using a trained Artificial Intelligence (AI) model, wherein the suggested natural language query is based at least in part on the trained AI model. When the identity of the one more descriptors and/or the desired result is ambiguous, the method 50 may include prompting the user via the chatbot to resolve the ambiguity via another entry into the chatbot, as indicated at block 72.

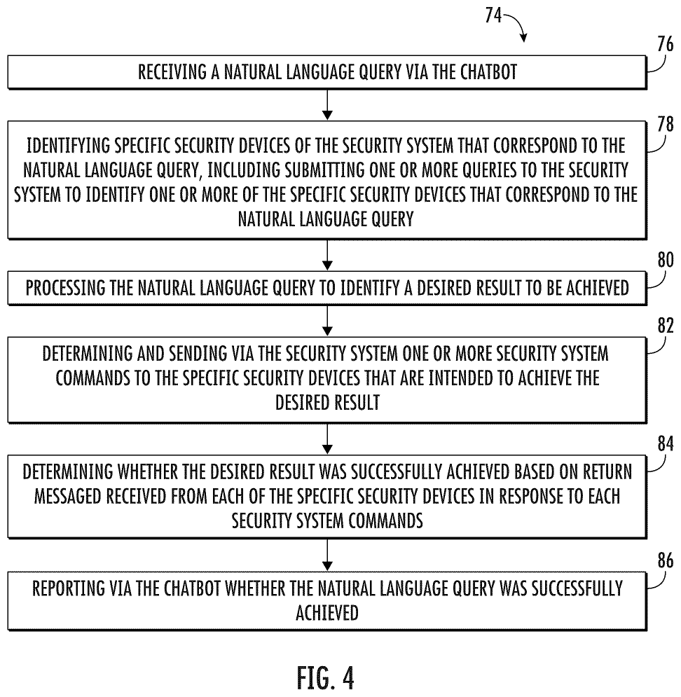

FIG. 4 is a flow diagram showing an illustrative method 74 of interacting with a user (such as the user 30) via a chatbot (such as the chatbot 14) to monitor and/or control one or more security devices (such as the security devices 16) of a security system (such as the security system 12) of a facility. The method 74 includes receiving a natural language query via the chatbot, as indicated at block 76. Specific security devices of the security system are identified that correspond to the natural language query, which includes submitting one or more queries to the security system to identify one or more of the specific security devices that correspond to the natural language query, as indicated at block 78. The natural language query is processed to identify a desired result to be achieved, as indicated at block 80. The method 74 includes determining and sending via the security system one or more security system commands to the specific security devices that are intended to achieve the desired result, as indicated at block 82. The method 74 includes determining whether the desired result was successfully achieved based on return messaged received from each of the specific security devices in response to each security system commands, as indicated at block 84. The method 74 includes reporting via the chatbot whether the natural language query was successfully achieved, as indicated at block 86. In some cases, this may also include reporting one or more reasons why the natural language query was not successfully achieved.

In some cases, submitting one or more queries to the security system to identify specific security devices that correspond to the natural language query may include one or more of submitting a query to identify one or more security system devices that have a specified device type, submitting a query to identify one or more security system devices that are located at a specified location in the facility, submitting a query to identify one or more security system devices that are located at a specified region of the facility, and/or submitting a query to identify one or more security system devices that have a specified current operational status. In some cases, identifying the desired result to be achieved may include processing the natural language query via a Large Language Model (LLM).

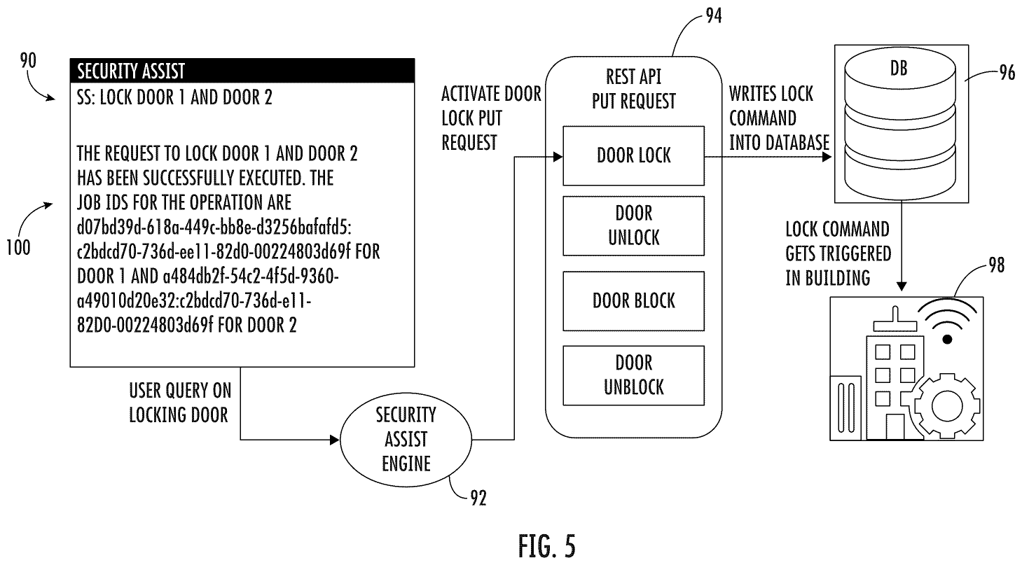

FIG. 5 is a schematic illustration of using a chatbot to issue commands to a security system and receiving confirmation thereof. A user issues a query to lock Door 1 and Door 2, as indicated at 90. The query passes to a security assist engine 92, which creates an activate door lock PUT request, which passes to block 94. Block 94 allows actions such as door lock, door unlock, door block and door unblock. The command is written into a database 96 and is triggered in the building, as indicated at block 98. Confirmation is provided back to the user, as indicated at 100.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for interacting with a user via a chatbot to monitor and/or control one or more security devices of a security system of a facility, the method comprising:
receiving a natural language query via the chatbot to monitor and/or control one or more security devices of the security system;
processing the natural language query to:
identify one or more descriptors of one or more security system devices that are a subject of the natural language query;
identify a desired result of the natural language query;
based at least in part on the identified one more descriptors, assembling and submitting one or more security system commands to the security system to identify one or more specific security system devices of the security system that correspond to the natural language query;
based at least in part on the desired result, assembling and submitting one or more security system commands to each of the specific security system devices of the security system that are tailored to achieve the desired result, and in response, receiving a return message from the security system for each of the one or more security system commands submitted to each of the specific security system devices of the security system;
based at least in part on the one or more return messages from the security system, determining whether the desired result was achieved; and
report via the chatbot whether the natural language query was carried out successfully, and if not, report one or more problems that were encountered.

2. The method of claim 1, wherein the natural language query is processed by a Large Language Model (LLM) that identifies the one or more descriptors of one or more security system devices that are the subject of the natural language query and identify the desired result of the natural language query.

3. The method of claim 1, wherein an orchestrator assembles and submits the one or more security system commands to the security system to identify the one or more specific security system devices of the security system that correspond to the natural language query.

4. The method of claim 3, wherein the orchestrator assembles and submits the one or more security system commands to each of the specific security system devices of the security system, and receives the return message from the security system for each of the one or more security system commands submitted to each of the specific security system devices of the security system.

5. The method of claim 4, wherein the orchestrator determines whether the desired result was achieved.

6. The method of claim 4, wherein a Large Language Model (LLM), operatively coupled to the orchestrator, reports via the chatbot whether the natural language query was carried out successfully, and if not, reports one or more problems that were encountered.

7. The method of claim 1, wherein the one or more descriptors identify one or more of:
a type of a security system device;
a location of a security system device in the facility;
a region of a security system device in the facility; and
a current operational status of a security system device.

8. The method of claim 1, comprising:
determining access rights of the user; and
determining whether the user has access rights to each of the specific security system devices of the security system, and if not, not submitting the one or more security system commands to the specific security system devices of the security system that the user lacks access rights.

9. The method of claim 1, comprising:
storing a plurality of historical natural language queries received over time; and
suggesting a natural language query to the user based at least in part on the plurality of historical natural language queries.

10. The method of claim 9, comprising:
processing the plurality of historical natural language queries received over time using a trained Artificial Intelligence (AI) model, wherein the suggested natural language query is based at least in part on the trained AI model.

11. The method of claim 1, wherein when the identity of the one more descriptors and/or the desired result is ambiguous, prompting the user via the chatbot to resolve the ambiguity.

12. A system for monitoring and/or controlling a security system of a facility comprising:
a security system including a plurality of security system devices;
a chatbot operatively coupled to the security system, the chatbot including:
a chatbot user interface for receiving a natural language query from a user;
a large language model interface for interfacing with a Large Language Model (LLM);
an orchestrator operatively coupled to the chatbot user interface, the large language model interface and the security system;
the orchestrator is configured to:
provide the natural language query received via the chatbot user interface to the LLM via the large language model interface, wherein the LLM is configured to identify and return:
one or more descriptors of one or more security system devices of the security system that are a subject of the natural language query;
a desired result of the natural language query;
assemble and submit one or more security system commands to the security system to identify one or more specific security system devices of the security system that correspond to the natural language query based at least in part on the identified one more descriptors;
assemble and submit one or more security system commands to each of the specific security system devices of the security system that are tailored to achieve the desired result based at least in part on the desired result, and in response, receive a return message from the security system for each of the one or more security system commands submitted to each of the specific security system devices of the security system;
determine whether the desired result was achieved based at least in part on the one or more return messages from the security system; and
provide whether the natural language query was carried out successfully to the chatbot user interface.

13. The system of claim 12, wherein the security system comprises a security system control application that includes a plurality of menus that can be navigated to monitor and control each of the plurality of security devices of the facility, wherein the chatbot user interface is integrated into the security system control application.

14. The system of claim 13, wherein the security system control application includes a floorplan that displays for each of one or more of the plurality of security devices:
a location of the corresponding security device on the floorplan;
an identifier of the corresponding security device; and
a current status of the corresponding security device.

15. The system of claim 14, wherein the natural language query includes a reference to one or more of the security device identifiers displayed on the floorplan.

16. The system of claim 12, wherein the orchestrator is configured to:
determine access rights of the user; and
determine whether the user has access rights to each of the specific security system devices of the security system, and if not, not submitting the one or more security system commands to the specific security system devices of the security system that the user lacks access rights.

17. A method of interacting with a user via a chatbot to monitor and/or control one or more security devices of a security system of a facility, the method comprising:
receiving a natural language query via the chatbot;
identifying specific security devices of the security system that correspond to the natural language query, including submitting one or more queries to the security system to identify one or more of the specific security devices that correspond to the natural language query;
processing the natural language query to identify a desired result to be achieved;
determining and sending via the security system one or more security system commands to the specific security devices that are intended to achieve the desired result;
determining whether the desired result was successfully achieved based on return messaged received from each of the specific security devices in response to each security system commands; and
reporting via the chatbot whether the natural language query was successfully achieved.

18. The method of claim 17, comprising:
when the natural language query was not successfully achieved, reporting one or more reasons via the chatbot.

19. The method of claim 17, wherein submitting one or more queries to the security system to identify specific security devices that correspond to the natural language query comprises one or more of:
submitting a query to identify one or more security system devices that have a specified device type;
submitting a query to identify one or more security system devices that are located at a specified location in the facility;
submitting a query to identify one or more security system devices that are located at a specified region of the facility; and
submitting a query to identify one or more security system devices that have a specified current operational status.

20. The method of claim 17, wherein identifying the desired result to be achieved comprises processing the natural language query via a Large Language Model (LLM).
